(19) United States
(12) Patent Application Publication
(10) Pub. No.: US 2016/0053079 A1
(43) Pub. Date: Feb. 25, 2016

(54) RESIN COMPOSITION AND ELECTRIC WIRE USING SAME

(71) Applicant: YAZAKI CORPORATION, Tokyo (JP)

(72) Inventor: Shuichi KIMURA, Shizuoka (JP)

(21) Appl. No.: 14/925,290

(22) Filed: Oct. 28, 2015

Related U.S. Application Data
(63) Continuation of application No. PCT/JP2014/061736, filed on Apr. 25, 2014.

(30) Foreign Application Priority Data
Apr. 30, 2013 (JP) 2013-095227

(51) Int. Cl. C08K 5/00; H01B 7/00; H01B 3/44; C08K 3/22; C08K 3/00

(52) U.S. Cl. CPC C08K 5/0008; C08K 3/22; C08K 3/0008; H01B 3/441; H01B 3/447; H01B 7/00; C08K 2003/2224

(57) ABSTRACT

A resin composition comprises a base resin containing an ethylene-acrylic acid ester copolymer as a main component; a lubricant dispersed in the base resin, the lubricant containing a metal soap; and a metal hydroxide in a range from 5 to 60 mass %. Such a resin composition can develop good flexibility and abrasion resistance. That is to say, the electric wire to which the resin composition of the present invention is applied can develop excellent flexibility and abrasion resistance.

### CROSS REFERENCE TO RELATED APPLICATION

This application is a Continuation of PCT Application No. PCT/JP2014/061736, filed on Apr. 25, 2014, and claims the priority of Japanese Patent Application No. 2013-095227, filed on Apr. 30, 2013, the content of all of which is incorporated herein by reference.

### BACKGROUND

1. Technical Field

The present invention relates to a resin composition usable for an insulating coating of an electric wire, and to an electric wire using this resin composition.

2. Related Art

For a wire harness cabled in an automobile, miniaturization thereof is required in order to contribute weight reduction and space saving of the automobile. Therefore, for an electric wire for use in the wire harness, diameter thinning is required. As a method for the diameter thinning, thinning of a thickness of an insulator is mentioned. Meanwhile, for the insulator for use in the electric wire, a variety of characteristics are required in response to a usage environment thereof. In particular, resistance to contact with a peripheral instrument, an adjacent electric wire, an exterior member and the like is required; however, if the thickness of the insulator is thinned, then abrasion resistance thereof tends to decrease. Therefore, it is necessary to design an insulator in which the abrasion resistance does not decrease even if the thickness of the insulator is thinned; however, an electric wire manufactured in such a manner tends to loose flexibility (that is, to be hardened). The above-described electric wire is sometimes cabled to be sharply bent in a short route, and in particular, in a hybrid vehicle, an electric vehicle or the like, a thick conductor with a cross-sectional area of 3 sq (mm²) or more is also sometimes used as a high-voltage electric wire of the wire harness. Therefore, such flexibility that does not allow an occurrence of a disadvantage at a processing time is required in consideration of convenience.

From a viewpoint of ensuring the flexibility, Patent Literatures 1 and 2 make a proposal to use an olefin-based resin as a material of the insulator.

Patent Literature 1 argues that good elongation of a resin composition, which coats the conductor, can be ensured by forming the resin composition from high-density polyethylene, and by performing crosslinking treatment for the resin composition by electron beam irradiation.

Patent Literature 2 describes that a resin composition (insulator) is formed from an ethylene-ethyl acrylate copolymer (EEA) in which a content of methyl acrylate is 15 mass % or more, from a thermoplastic olefin resin, and from a non-halogen flame retardant, and that the EEA is subjected to silane crosslinking The above-described resin composition is provided with elongation capable of coping with high-speed extrusion molding, and becomes an extremely flexible resin.

Patent Literature 1: Japanese Unexamined Patent Application Publication No. H06-333435

Patent Literature 2: Japanese Unexamined Patent Application Publication No. 2009-298831

### SUMMARY

The resin composition described in Patent Literature 1 is provided with good elongation when a thickness there of 0.3 mm or less. Moreover, it is described that the resin composition is applicable to a conductor in which a cross-sectional area is 2 sq or less. That is to say, the resin composition has a problem in a point that the resin composition cannot ensure the flexibility of the electric wire in a case of being applied to a conductor, for example, in which a cross-sectional area is 3 sq or more. Moreover, though the resin composition described in Patent Literature 2 is flexible, the resin composition has a problem in that the content of methyl acrylate is 15 mass % or more, which results in small abrasion resistance. As described above, it can be said that the abrasion resistance and the flexibility are in a trade-off relationship, and it has been difficult to strike a balance between both of these.

The present invention has been made in consideration of such problems as described above, which are inherent in the prior art. Then, it is an object of the present invention to provide a resin composition, which is capable of ensuring excellent flexibility even if being applied to an insulating coating material of an electric wire including the conductor in which a cross-sectional area is 3 sq or more, and in addition, is capable of ensuring excellent abrasion resistance. It is another object of the present invention to provide an electric wire using the resin composition.

A resin composition according to a first aspect of the present invention is summarized to include: a base resin containing an ethylene-acrylic acid ester copolymer as a main component; and a lubricant dispersed in the base resin, the lubricant containing a metal soap.

An electric wire according to a second aspect of the present invention is summarized to include: an insulating layer containing the resin composition of the first aspect; and a conductor coated with the insulating layer.

An electric wire according to a third aspect of the present invention relates to the electric wire of the second aspect, summarized in that a cross-sectional area of the conductor is 3 sq or more, and a thickness of the insulating coating layer is 0.32 mm or more.

An electric wire according to a fourth aspect of the present invention relates to the electric wire of the second or third aspect, summarized to further include: a shield layer coating the insulating coating layer; and a sheath layer coating the shield layer.

### BRIEF DESCRIPTION OF DRAWINGS

FIG. 1 is a cross-sectional view showing an electric wire according to a first embodiment of the present invention.

FIG. 2 is a cross-sectional view showing an electric wire according to a second embodiment of the present invention.

### DETAILED DESCRIPTION

A description is made below in detail of embodiments of the present invention by using the drawings. Note that dimensional ratios of the drawings are exaggerated for convenience of explanation, and are sometimes different from actual ratios.

### [Resin Composition]

A description is made in detail of a resin composition according to an embodiment of the present invention. The resin composition of this embodiment includes: a base resin; and a lubricant, which is added to this base resin, and contains a dispersed metal soap.

The above-described base resin stands for a main component in a resin composition. Therefore, the resin composition of this embodiment can contain other components within a range of not inhibiting functions of the base resin as the main component. Here, the main component stands for that the component concerned occupies 50 mass % or more of a whole of the composition. In this embodiment, as the base resin, for example, one is used, which contains an ethylene-acrylic acid ester copolymer as a main component. The base resin itself as described above has flexibility, and accordingly, can impart good flexibility to an electric wire in a case where the resin composition of this embodiment is formed as an insulator of the electric wire. If the base resin is contained by 50 to 99 mass % in the resin composition of this embodiment, then this is preferable since the electric wire can ensure sufficient flexibility.

In this embodiment, as the base resin, one with which one or more types of ethylene-based resins or the like are mixed can be used besides the ethylene-acrylic acid ester copolymer. Moreover, as the base resin, one can be used, which is obtained by mixing another ethylene copolymer such as an ethylene-vinyl acetate copolymer and an ethylene-vinyl alcohol copolymer with the above-described ethylene-acrylic acid ester copolymer.

As the above-described ethylene-based resin, for example, there can be used: polyethylene obtained by polymerizing ethylene; and an ethylene copolymer having polyethylene as a portion thereof. These are compounded with the ethylene-acrylic acid ester copolymer, whereby the base resin can be formed.

As the above-described polyethylene, each of high-density polyethylene (HDPE), low-density polyethylene (LDPE) and linear low-density polyethylene (L-LDPE) can be used singly, or a plurality thereof can be used by mixture. Note that one with a high density has high crystallinity, and tends to be hardened. Therefore, if the low-density polyethylene and the linear low-density polyethylene, each of which has low crystallinity and has a low density, is used, then the electric wire can ensure sufficient flexibility, and this is preferable. From a similar viewpoint, even in a case of using the high-density polyethylene, it is preferable to raise a compound ratio of the low-density polyethylene to an extent at which such sufficient flexibility can be ensured.

As the acrylic acid ester to be contained in the base resin, each of ethyl acrylate, methyl acrylate, butyl acrylate, propyl acrylate, ethylhexyl acrylate, hydroxyethyl acrylate and the like may be used singly, or a plurality thereof may be used by mixture. These acrylic acid esters are selected in consideration of flexibility in a case of being copolymerized with ethylene. If the low-density ethyl acrylate (ethylene-ethyl acrylate copolymer (EEA)) or the low-density methyl acrylate (ethylene-methyl acrylate copolymer (EMA) is used, then the electric wire can ensure sufficient flexibility, and this is preferable.

Note that crosslinking treatment is performed in an event of using the resin composition of this embodiment as an insulating coating layer. At this time, if the high-density polyethylene is crosslinked by electron beam irradiation and the like, then a degree of crosslinking is low, and resistance to heat decreases. In contrast, in a case of using the low-density polyethylene and the low-density ethylene-acrylic acid ester copolymer, which are as mentioned above, as the base resin, then a high-level degree of crosslinking can be held by the crosslinking treatment, and accordingly, this is preferable. If such a configuration is adopted, then a resin composition developing such heat resistance that can satisfy the heat resistance Class D of ISO 6722-1 can be obtained.

The resin composition of this embodiment includes a lubricant containing a metal soap in addition to the above-described base resin, and accordingly, can develop excellent abrasion resistance. Note that, for the purpose of enhancing the abrasion resistance, it is also conceived to add engineering plastics such as polycarbonate and super engineering plastics such as a liquid crystal polymer. However, in general, these materials are hard and have a high elastic modulus. In contrast, the resin composition of this embodiment, with which the above-described metal soap is compounded, can ensure the abrasion resistance even if the engineering plastics and the super engineering plastics are not added thereto. As described above, with regard to the resin composition of this embodiment, it is not necessary to add the engineering plastics and the super engineering plastics thereto, and the above-described base resin can be used positively, and accordingly, it is not necessary to consider changes of physical property values such as hardness and elastic modulus of the resin.

The metal soap is salt of long-chain fatty acid and metal other than sodium and potassium. As the fatty acid, there can be used stearic acid, hydroxystearic acid, behenic acid, montanoic acid, octylic acid, palmitic acid, lauric acid, myristic acid, ricinoleic acid, and the like. As the metal, calcium, magnesium, zinc, aluminum, lithium and the like can be used.

Specifically, as the metal soap, there can be used lithium stearate, magnesium stearate, calcium stearate, zinc stearate, aluminum stearate, magnesium hydroxystearate, calcium hydroxystearate, zinc hydroxystearate, aluminum hydroxystearate, lithium behenate, magnesium behenate, calcium behenate, zinc behenate, aluminum behenate, lithium montanate, magnesium montanate, calcium montanate, zinc montanate, aluminum montanate and the like. As the metal soap, each of these can be used singly, or two or more of these can be used in combination.

The lubricant containing the metal soap has a function to lower adhesion strength between a conductor composed of metal and the like and a resin composition that coats the conductor. That is to say, in a case of using the resin composition of this embodiment as the insulating coating layer of the electric wire, a part of a metal soap component is present on a boundary between the resin composition and metal and the like of a core wire and the like, whereby the adhesion strength between the insulating coating layer and conductor of the electric wire can be lowered.

Note that, if the adhesion strength between the resin composition and the conductor of the metal and the like is small, then affinity between the conductor and the coating insulating layer formed of the resin composition can be prevented from becoming higher than necessary, and accordingly, the electric wire using the resin composition of this embodiment can ensure sufficient flexibility. That is to say, the electric wire, on which the insulating coating layer using the resin composition of this embodiment is formed, can prevent a degree of freedom in electric wire cabling from being lowered.

As described above, in the resin composition of this embodiment, if the metal soap is added to adjust the adhesion strength between the insulating coating layer and the conductor, then flexibility and abrasion resistance, which are good for the electric wire, can be imparted to the insulating coating layer formed of the resin composition. For example, to an extent of enabling the insulating coating layer to move in parallel to abrasion paper at a time of an abrasion test, a degree of freedom in motion of the insulating coating layer can be increased. Therefore, the insulating coating layer using the resin composition of this embodiment has an effect of increasing resistance of the abrasion paper to cutting pressure to be hardly deformed plastically.

The above-described adhesion strength can be quantitatively evaluated by performing measurement conforming to ISO 6722-1 (Section 5.9). In this embodiment, it is preferable that the lubricant containing the metal soap is such a material in which adhesion strength with the conductor of the metal and the like becomes 40 N or less. More specifically, it is preferable that the lubricant containing the metal soap is such a material in which the adhesion strength with the conductor or the metal and the like, which is obtained in the measurement conforming to ISO 6722-1 (Section 5.9) described above, becomes 40 N or less. In a case where the adhesion strength between the lubricant and the conductor is 40 N or less, adhesion properties between the resin composition and the conductor of the metal and the like does not become larger than necessary, and the abrasion resistance of the insulating coating layer can be ensured sufficiently. A lower limit value of the adhesion strength is appropriately selected in consideration of the abrasion resistance of the insulating coating layer.

The resin composition of this embodiment can also be allowed to contain a filler. As the filler, for example, calcium carbonate, talc, clay and the like can be used. Note that the above-described lubricant also has a function to prevent aggregation of the filler in the resin composition. That is to say, if the above-described lubricant is added to the above-described base resin, then dispersivity of the filler in the resin composition can be enhanced. As a result in the resin composition of this embodiment, an occurrence of a defect in the resin composition is prevented. Note that this defect is one that can be an origin of a fracture in an event where the fracture occurs. Therefore, the resin composition of this embodiment hardly fractures. Moreover, in the case of using the resin composition of this embodiment for the electric wire, the insulating coating layer composed of the resin composition also contributes to reduction of irregularities of a surface of the electric wire. Note that the irregularities are also those which can become the origin in the event where the fracture occurs in the electric wire. Therefore, the electric wire using the resin composition of this embodiment is hardly broken. The lubricant prevents the occurrence of the defect as described above, whereby not only the abrasion resistance of the insulating coating layer is ensured but also a decrease of mechanical properties, the decrease including the fracture of the electric wire, and the like, can be suppressed.

From the above-described variety of viewpoints, it is preferable that the lubricant containing the metal soap be contained by 0.1 to 20 mass % with respect to the whole of the resin composition. It is more preferable that such a content of the lubricant be 2 to 10 mass %.

To the resin composition of this embodiment, a metal hydroxide as a flame retardant can be added in addition to the above-described base resin and lubricant. By this metal hydroxide, flame retardance is imparted to the resin composition. As the metal hydroxide, one or a plurality of metal compounds, which have a hydroxyl group or water of crystallization, can be used. As the metal hydroxide, there are mentioned magnesium hydroxide (Mg(OH)₂), aluminum hydroxide (Al(OH)₃), calcium hydroxide (Ca(OH)₂), basic magnesium carbonate (mMgCO₃.Mg(OH))₂nH₂O), hydrated aluminum silicate (Al₂O₃.3SiO₂.nH₂O), hydrated magnesium silicate (Mg₂Si₃O₈.5H₂O) and the like. Among them, magnesium hydroxide is preferably used.

As the above-described metal hydroxide, one is preferable, which is subjected to surface treatment in consideration of compatibility with the base resin. As a matter of course, even if the surface treatment is not implemented for the metal hydroxide, the metal hydroxide can be used within a range where physical properties as a whole of the resin composition according to this embodiment are not deteriorated. It is preferable to perform the surface treatment for the metal hydroxide by using a silane coupling agent, a titanate coupling agent, or fatty acid such as stearic acid, fatty acid metal salt such as calcium stearate, and the like.

The above-described metal hydroxide is added to the resin composition according to this embodiment, whereby it is not necessary to use a halogen-based flame retardant such as bromine, and the resin composition according to this embodiment can be formed as a halogen-free one. In this case, the resin composition according to this embodiment can be formed as one that applies a less load to the environment and is excellent in recycling efficiency, and accordingly, this is preferable.

Note that, if the metal hydroxide is added excessively, a large amount of voids (minute defects) are prone to be generated in an inside of the resin composition, and moreover, in an event where the electric wire is worn out, the filler in the resin composition (insulating coating layer) becomes prone to be desorbed. Therefore, such excessive addition of the metal hydroxide can become a cause of decreasing the abrasion resistance since the desorbed filler serves as an abrasive. Hence, a compounded amount of the metal hydroxide is set in consideration of these. From the above-described viewpoint, it is preferable to set the compounded amount at 5 to 60 mass %.

Note that, in order to prevent the above-mentioned defect in the resin composition, and to ensure the abrasion resistance, it is conceived to prevent desorption of the filler by enhancing compatibility between the filler and the resin as well as to prevent the aggregation of the filler by the lubricant as mentioned above. Therefore, in order to prevent the defect in the resin composition and to ensure the abrasion resistance, it is preferable to select materials in consideration of dispersivity of the filler in the resin composition. In the resin composition of this embodiment, the above-described lubricant is used, and accordingly, the aggregation of the filler can be prevented, and in addition, the abrasion resistance can be ensured without using a high crystalline resin. That is to say, in the resin composition of this embodiment, a resin in which it is easy to disperse the filler can be selected without using the high crystalline resin in which it is hard to disperse the filler. Specifically, in the resin composition of this embodiment, the ethylene-acrylic acid ester copolymer, which is low crystalline and is capable of favorably taking the filler thereinto, is selected. Moreover, in the resin composition of this embodiment, other olefin-based resins are also compounded suitably.

In the resin composition of this embodiment, a variety of additives, which are other than the above-described materials, can be compounded within a range of not inhibiting the effects of this embodiment. As the additives to be compounded, there are mentioned a flame retardant, a flame retardant promoter, an antioxidant, a metal deactivator, an anti-aging agent, a reinforcing agent, an ultraviolet absorber, a stabilizer, a plasticizer, pigment, dye, a colorant, an antistatic agent, a foaming agent, and the like.

### [Electric Wire]

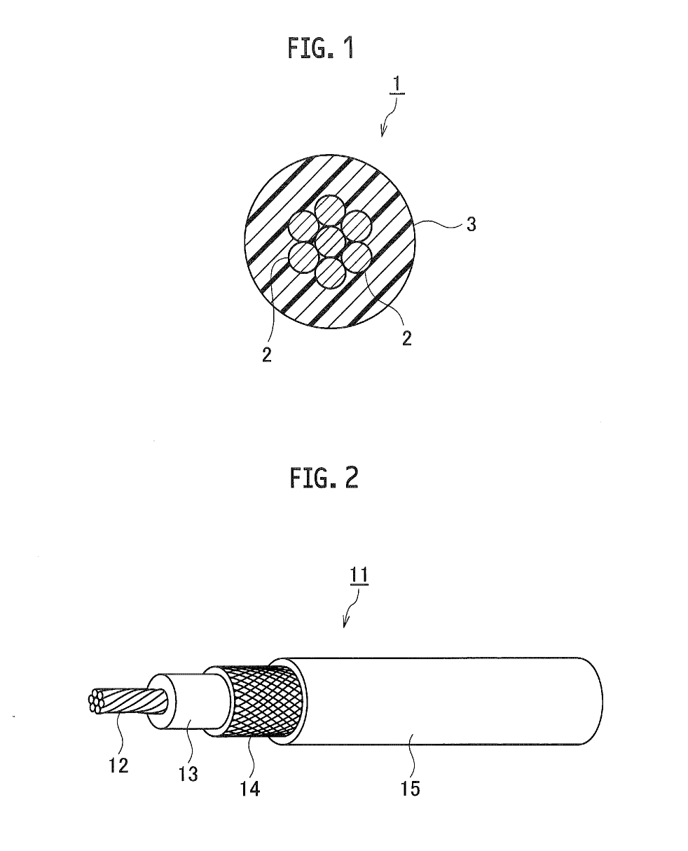

FIG. 1 shows an example of an electric wire according to an embodiment of the present invention. As shown in FIG. 1, an electric wire 1 is formed by coating a conductor 2, which is composed of metal and the like, with an insulating coating layer 3 made of the resin composition of the above-described embodiment. Here, the resin composition, which composes the insulating coating layer 3, contains: the base resin containing the ethylene-acrylic acid ester copolymer as a main component; and the lubricant, which is made of the metal soap and is added to the base resin. In such a way, the electric wire 1 of this embodiment can exert excellent flexibility and abrasion resistance. Moreover, the electric wire 1 of this embodiment not only satisfies these desired physical properties, but also is imparted with the heat resistance conformed to Class D of ISO 6722-1.

The conductor 2 composed of metal and the like may be only a single wire, or may be one formed by bundling a plurality of wires. As a material of the conductor 2, for example, there can be used conductive metal such as copper, plated copper, copper alloy, aluminum and aluminum alloy.

As described above, while ensuring sufficient abrasion resistance, the electric wire 1 of this embodiment can exert sufficiently high flexibility even if the electric wire 1 is an electric wire in which a conductor cross-sectional area is 3 sq or more, the electric wire being able to be said to be a small-diameter electric wire with a thin-wall structure with reference to the standard ISO 6722-1. As a result, the electric wire 1 is excellent in handling properties as an electric wire and a wire harness, and accordingly, can contribute to not only efficiency enhancement of cabling work, but also manufacturing cost reduction for vehicles.

The insulating coating layer 3 has the above-described desired physical properties, and accordingly, in the electric wire 1 of this embodiment, the cross-sectional area of the conductor 2 can be set at 3 sq or more, and the thickness of the insulating coating layer 3 can be set at 0.32 mm or more. That is to say, in this embodiment, as the thickness of the insulating coating layer 3, a value can be adopted, which adapts to the structure of “Thin Wall” defined in the standard ISO 6722-1. From a viewpoint of allowing the thickness of the insulating coating layer 3 to adapt to the above-described standard, the thickness of the insulating coating layer 3 is preferably 0.32 mm or more to 1.90 mm or less. Moreover, the thickness of the insulating coating layer 3 can be appropriately adjusted based on the value of the cross-sectional area or diameter of the conductor 2. Specifically, the thickness of the insulating coating layer 3 can be set in conformity with relationships of the respective sizes shown in Table 4 (Dimensions) in the above-described standard. Even in a case of using a thick metal conductor with a cross-sectional area of 3 sq or more as a core wire, the electric wire 1 that adopts the above-described configuration has good handling properties, and can be easily cabled into an automobile. Note that, in the electric wire 1, based on the above-described standard, the cross-sectional area of the conductor 2 is set at preferably 3 sq or more to less than 120 sq, more preferably 3 sq or more to 95 sq or less. In a case where the insulating coating layer 3 having the above-described cross-sectional area is formed on the conductor 2 having the cross-sectional area as described above, then the electric wire 1 can be evaluated to have a thin-wall structure that adapts to the above-described standard. More specifically, the diameter of the electric wire 1 is preferably more than 3.00 mm to less than 18.00 mm, more preferably 3.40 mm or more to 16.70 mm or less. Moreover, the electric wire 1 as described above satisfies the heat resistance Class D of ISO 6722-1, and accordingly, is suitable for practical use as a high-voltage electric wire of a hybrid vehicle, a plug-in hybrid vehicle and an electric vehicle. More specifically, the electric wire 1 is preferable since the electric wire 1 is free from apprehension of quality in an event of being put into practical use as a thick electric wire for a high-voltage circuit, for the hybrid car, the plug-in hybrid car and the electric vehicle.

Next, a description is made of a manufacturing method of the electric wire 1 of this embodiment. The insulating coating layer 3 is prepared by kneading the materials, which form the resin composition of the above-mentioned embodiment, and means known in public can be used as a method of this preparation. For example, there can be adopted a method for obtaining the resin composition, which composes the insulating coating layer 3, in such a manner that the materials are pre-blended by using a high-speed mixing device such as a Henschel mixer in advance, and thereafter, are kneaded by using a publicly known kneader such as Banbury mixer, a kneader, and a roll mill.

In the electric wire 1 of this embodiment, publicly known means can be used also as a method of coating the conductor 2 with the insulating coating layer 3. For example, the insulating coating layer 3 can be formed by a general extrusion molding method. As an extruder for use in the extrusion molding method, for example, a single screw extruder and a twin screw extruder are used. The extruder includes a screw, a breaker plate, a cross head, a distributer, a nipple, and a dice.

In the case of preparing the resin composition of the insulating coating layer 3, for example, a method as below can be adopted. That is to say, first, polyethylene and ethylene-acrylic acid ester are poured into the twin screw extruder set at a temperature at which the polyethylene and the ethylene-acrylic acid ester are fused sufficiently. In this event, the metal hydroxide can be poured, and further, other components such as the flame retardant, the flame retardant promoter and the antioxidant can also be poured according to needs. Next, the ethylene-acrylic acid ester, the polyethylene and the like are fused, kneaded, and extruded. The resin composition with a continuously columnar shape, which is extruded as described above, is cooled by passing via a water tank, and is cut into a pellet shape by a pelletizer. Pellet-shaped objects thus obtained become an insulating coating material. For example, this insulating coating material is first poured into the single screw extruder, and is fused and kneaded by a screw, and a fixed amount thereof is supplied to the cross head via the breaker plate. Next, the fused insulating coating material flows into a circumference of the nipple by the distributer, is extruded in a state of being coated onto an outer circumference of the metal conductor by the dice, and forms the insulating coating layer 3. In such a way, the insulating coating layer 3 that coats an outer circumference of the conductor 2 can be obtained.

The insulating coating layer 3, which coats the outer circumference of the conductor 2, is subjected, for example, to the crosslinking treatment by the electron beam irradiation and the like. The electric wire 1 of this embodiment uses the resin composition, which contains the desired base resin, as a precursor of the insulating coating material, and accordingly, can hold a high-level degree of crosslinking by being subjected to the crosslinking treatment by the electron beam irradiation. Therefore, the resistance of the insulating coating layer 3 to heat is increased, and the electric wire 1 provided with high heat resistance is obtained.

FIG. 2 shows another example of the electric wire according to this embodiment. This electric wire 11 can also be called a shielded electric wire, and includes: a conductor 12 made of metal and the like; an insulating coating layer 13 that coats the conductor 12; a shield layer 14 that coats the insulating coating layer 13; and a sheath layer 15 that further coats the shield layer 14.

In a similar way to the above-mentioned conductor 2, the conductor 12 may be a single wire, or may be formed by bundling a plurality of wires. The shield layer 14 is formed of conductive metal foil, or of foil containing metal, or by knitting metal wires (metal conductors) into a mesh shape.

In a similar way to the above-mentioned insulating coating layer 3 in the electric wire 1, the insulating coating layer 13 in this embodiment can be formed by using the resin composition of the above-described embodiment. The resin composition, which composes the insulating coating layer 13, contains: the base resin containing the ethylene-acrylic acid ester copolymer as a main component; and the lubricant, which is made of the metal soap and is added to the base resin. As described above, the electric wire 11 includes the insulating coating layer 13 composed of the specific resin composition, and accordingly, can ensure sufficient abrasion resistance. Moreover, in accordance with such a configuration, the insulating coating layer 13 has excellent flexibility, and accordingly, the electric wire 11 can be formed as one easy to cable. From a viewpoint of ensuring the degree of freedom in electric wire cabling, and achieving weight reduction and miniaturization, a diameter of the electric wire 11 is preferably a value adapting to the structure of “Thin Wall” defined in the standard ISO 6722-1.

In the electric wire 11 of this embodiment, the shield layer 14 is formed, and accordingly, unnecessary emission of an electromagnetic wave from the electric wire 1 can be prevented. As a material of the shield layer 14 that exerts such a function, metal such as copper, silver and aluminum can be used. A thickness of the shield layer 14 is not particularly limited; however, a thinner thickness is more preferable, and the thickness can be set appropriately in combination with shield performance.

In the electric wire 11 of this embodiment, the sheath layer 15 that coats the shield layer 14 is formed and accordingly, the shield layer 14 can be protected and housed effectively. A material of the sheath layer 15, which exerts such a function, is not particularly limited; however, olefin resin such as polyethylene, and the like can be used. A thickness of the sheath layer 15 is not particularly limited; however, a thinner thickness is more preferable, and preferably, the thickness is set at a value conforming to the standard prescribed in ISO 14572.

The electric wire 11 of this embodiment can be manufactured in a similar way to the case of the above-mentioned electric wire 1. That is to say, first, the conductor 12 composed of metal and the like is coated with the insulating coating layer 13 by the extrusion molding and the like. Thereafter, for example, a braided wire formed by bundling a plurality of single wires is knitted onto the insulating coating layer 13. Moreover, similar treatment to that for the insulating coating layer 3 of the electric wire 1, whereby the sheath layer 15 is coated, and the electric wire 11 can be manufactured.

In the electric wire 11 of this embodiment, the insulating coating layer 13 uses the resin composition having excellent flexibility and abrasion resistance, and accordingly, the insulating coating layer 13 can be thinned, and the weight reduction and miniaturization of the electric wire 11 can be achieved. Moreover, the handling properties of the electric wire 11 are good, and it becomes easy to cable the electric wire 11 into the automobile. Furthermore, the electric wire 11 of this embodiment satisfies the heat resistance Class D of ISO 6722-1, and accordingly, can be suitably used as a high-voltage electric wire of the hybrid vehicle, the plug-in hybrid vehicle and the electric vehicle.

### EXAMPLES

A description is made below in more detail of examples and comparative examples of the present invention; however, the present invention is not limited to these examples.

In Example 1, first, materials shown in Table 1 were prepared as the resin composition. That is to say, as the ethylene-acrylic acid ethyl copolymer, the trade name “Rexpearl (registered trademark) A1100” made by Japan Polyethylene Corporation was used. Moreover, as the polyethylene, the trade name “Novatec (registered trademark) HB 120R” made by Japan Polyethylene Corporation was used. As the metal soap-based lubricant, the trade name “ZS-7” made by Nitto Kasei Kogyo K.K. was used. As a polymer-based lubricant A, the trade name “Hi-WAX (registered trademark) 400P” made by Mitsui Chemicals, Inc. was used, and as a polymer-based lubricant B, the trade name “BY-27” made by Dow Corning Toray Co., Ltd. was used. As the magnesium hydroxide, the trade name “V6” made by Konoshima Chemical Co., Ltd., which was subjected to silane coupling treatment, was used.

A copper wire with a cross-sectional area of 3 sq was used as the conductor 2, and this metal conductor was coated with the insulating coating layer 3 with a wall thickness of 0.4 mm in such a manner that the resin composition containing the above-described compounded materials was subjected to the extrusion molding, whereby an electric wire corresponding to Example 1 was fabricated. Not that the above-described cross-sectional area and wall thickness are values conforming to ISO 6722-1.

As shown in Table 1, the respective electric wires according to Example 2 and Comparative Examples 1 to 6 were prepared in a similar way to Example 1 except that compound ratios of the respective materials were changed. Then, adhesion strength, abrasion resistance, heat resistant life and flexibility of each of the wires according to Examples 1, 2 and Comparative Examples 1 to 6 were evaluated.

### (Adhesion Strength)

For the adhesion strength, values measured in conformity with ISO 6722-1 (Item 5.9) were employed.

### (Abrasion Resistance)

For the evaluation of the abrasion resistance, sand paper abrasion resistance was measured by using sand paper with a garnet of 150 J in conformity with ISO 6722-1. In this measurement/evaluation, it was determined whether each example was accepted or rejected based on an index that an abrasion amount is 330 mm or less under a load of 1500 g. Those accepted were written as “∘”, and those rejected were written as “x”. Evaluation results of the heat resistance and the flexibility, which will be described below, were also written in Table 1 in a similar way.

### (Heat Resistant Life)

The heat resistant life was measured/evaluated in conformity with the heat resistance Class D of ISO 6722-1, and it was determined whether each example was accepted or rejected. That is to say, this determination was made while taking, as a reference, that a lifetime estimated by the Arrhenius model equation was 1500 h under a condition of 150° C.

### (Flexibility)

With regard to the flexibility, an electric wire bending stress was measured by using a tensile tester in conformity with LV 112. In this measurement/evaluation, it was determined whether each example was accepted or rejected based on an index that the electric wire bending stress was 40 N or less.

TABLE 1

| | | | | | | | Evaluation result | | | |
|---|---|---|---|---|---|---|---|---|---|---|
| | | | | | | | | | Accepted/ | |
| | Content (mass %) | | | | | | | | rejected in | |
| | Ethylene-acrylic | | Metal soap- | Polymer- | Polymer- | | Adhesion | | heat resistant | Accepted/ |
| | acid ester | Poly- | based | based | based | | strength | Abrasion | life (° C.) | rejected in |
| Category | copolymer resin | ethylene | lubricant | lubricant A | lubricant B | Mg(OH)₂ | (N) | resistance | Class D | flexibility |
| Example 1 | 58 | 20 | 2 | — | — | 20 | 28.2 | ∘ | ∘ | ∘ |
| Example 2 | 50 | 20 | 10 | — | — | 20 | 26.3 | ∘ | ∘ | ∘ |
| Comparative | 58 | 20 | — | 2 | — | 20 | 73.5 | x | ∘ | ∘ |
| Example 1 | | | | | | | | | | |
| Comparative | 50 | 20 | — | 10 | — | 20 | 45.3 | x | ∘ | ∘ |
| Example 2 | | | | | | | | | | |
| Comparative | 58 | 20 | — | — | 2 | 20 | 43.5 | x | ∘ | ∘ |
| Example 3 | | | | | | | | | | |
| Comparative | 50 | 20 | — | — | 10 | 20 | 35.3 | x | ∘ | ∘ |
| Example 4 | | | | | | | | | | |
| Comparative | — | 20 | — | — | — | 20 | 45.2 | ∘ | x | x |
| Example 5 | | | | | | | | | | |
| Comparative | 60 | 20 | — | — | — | 20 | 82.9 | x | ∘ | ∘ |
| Example 6 | | | | | | | | | | |

As shown in Table 1, Examples 1 and 2 were accepted by being determined to exceed such target values in all of the characteristics which were the abrasion resistance, the heat resistance and the flexibility though the insulating coating layers thereof were as thin as 0.4 mm Comparative Examples 1 to 4 used the lubricants other than the metal soap, and the abrasion resistance of each thereof was poor. Comparative Example 5 used the polyethylene as the base resin, and was thereby accepted in terms of the abrasion resistance; however, was rejected in terms of the heat resistant life and the flexibility. Comparative Example 6 was not added with the lubricant made of the metal soap, and was rejected in terms of the abrasion resistance.

As apparent from the above-described comparison between the examples and the comparative examples, with regard to the electric wires, each of which is obtained by using the resin composition that satisfies the configuration desired by the present invention, the adhesion force between the conductor and the insulating coating layer is reduced. Hence, each of the electric wires is recognized to be capable of developing excellent abrasion resistance, heat resistant life and flexibility.

In the resin composition of the present invention, the lubricant containing the metal soap is dispersed into the base resin containing the ethylene-acrylic acid ester copolymer as a main component, and accordingly, the resin composition of the present invention can develop good flexibility and abrasion resistance. That is to say, the electric wire to which the resin composition of the present invention is applied can develop excellent flexibility and abrasion resistance.

The description has been made above of the present invention by the examples and the comparative examples; however, the present invention is not limited to these, and is modifiable in various ways within the scope of the spirit of the present invention.

What is claimed is:

1. A resin composition comprising:
a base resin containing an ethylene-acrylic acid ester copolymer as a main component;
a lubricant dispersed in the base resin, the lubricant containing a metal soap; and
a metal hydroxide in a range from 5 to 60 mass %.

2. An electric wire comprising:
an insulating coating layer containing the resin composition according to claim 1; and
a conductor coated with the insulating coating layer.

3. The electric wire according to claim 2,
wherein a cross-sectional area of the conductor is 3 sq or more, and
a thickness of the insulating coating layer is 0.32 mm or more.

4. The electric wire according to claim 2, further comprising:
a shield layer coating the insulating coating layer; and
a sheath layer coating the shield layer.
